(19) United States
(12) Patent Application Publication
(10) Pub. No.: US 2009/0022645 A1
(43) Pub. Date: Jan. 22, 2009

(54) BLEACHING ACTIVATOR AND DETERGENT COMPOSITION COMPRISING THE SAME

(75) Inventors: Yasutaka Sumida, Neyagawa-shi (JP); Koji Yonehara, Nagaokakyo-shi (JP)

Correspondence Address: CONNOLLY BOVE LODGE & HUTZ LLP, 1875 EYE STREET, N.W., SUITE 1100, WASHINGTON, DC, 20006, US

(73) Assignee: NIPPON SHOKUBAI CO., LTD., Osaka-shi (JP)

(21) Appl. No.: 11/813,748

(22) PCT Filed: Jan. 11, 2006
(86) PCT No.: PCT/JP2006/300213

§ 371 Date: Jul. 21, 2008

(30) Foreign Application Priority Data
Jan. 12, 2005 (JP) 2005-005669

(51) Int. Cl. C01B 33/20; C01B 25/00

(52) U.S. Cl. 423/307; 423/326; 423/305

(57) ABSTRACT

To provide a bleaching activator capable of improving bleaching performance of a peroxy compound and the like, and a detergent composition comprising such a compound. A bleaching activator comprising Keggin heteropolyoxometalate anions, wherein the Keggin heteropolyoxometalate anions comprise a Keggin heteropolyoxometalate anion represented by the following formula (1):

[XMₐ(H₂O)_{b}O_{c}]^{d-} (1)

(in the formula, X representing a silicon atom or a phosphorus atom; M being the same or different and representing a tungsten atom or a molybdenum atom; a representing an integer of 9 to 11; b representing a positive number of 0 to 6; c representing a positive number of 28 to 39; d representing a valency and being a positive number).

### TECHNICAL FIELD

The present invention relates to bleaching activators and detergent compositions containing such compounds. More specifically, the present invention relates to: a bleaching activator capable of exhibiting high detergency as a bleaching activator for industrial or household use when used with a bleaching agent; and a detergent composition containing such a compound.

### BACKGROUND ART

Oxygen bleaching agents have been known as a bleaching agent, and such agents have functions of bleaching stains on clothes and the like, removing stains such as tea stains on ceramic, glass, or plastic tablewares, and the like. Hydrogen peroxide, organic/inorganic peracids, (for example, perboric acid, and percarbonic acid), and the like may be mentioned as typical compounds that are such oxygen bleaching agents. Such compounds function as an oxidant for soil components. Bleaching activators such as tetraacetylethylenediamine (TAED) and nonanoyloxybenzene sulfonate (NOBS) are often used together for improvement in efficiency of the bleaching agents. These bleaching activators form peroxides, thereby improving bleaching efficiency. Such a reaction of forming peroxides is a stoichiometric reaction, and therefore, for obtaining effects, the bleaching activator needs to be sufficiently added, which results in increase in costs.

With respect to conventional bleaching agents, it is disclosed that polyoxometalate having a specific structure is used as a bleaching activator to activate a peroxy compound formed from a bleaching agent and a bleaching activator (for example, refer to Japanese Kokai Publication No. Hei-09-118899 (pages 2 to 8)). This bleaching activator has a structure in which isopolyoxometalate containing a metal ion and oxygen and heteropolyoxometalate containing a nonmetal ion, a semi-metal ion, and/or a transition metal ion in addition to a metal ion and oxygen are contained. If the bleaching activator has a deficient structure in which an originally existing atom is deficient in the crystal structure, a metal element is contained, that is, the polyatom is substituted with another metal element. This bleaching activator is a polyoxometalate essentially containing any of elements belonging to 2 to 8 Groups such as Mn, V, Ti, Fe, Co, Cu, Zn, and Ni, and a Mn-containing polyoxometalate is disclosed in Example.

However, such a bleaching activator has room for improvement in order to improve an effective utilization rate of bleaching agents, extremely suppress inefficient decomposition of bleaching agents, and enable generated species for activating oxidation to be effectively used for oxidation of substrates.

### DISCLOSURE OF THE INVENTION

### Problem to be Solved by the Invention

The present invention has been made of the above-mentioned state of the art. The present invention has an object to provide: a bleaching activator capable of improving bleaching performance of a peroxy compound and the like; and a detergent composition containing such a compound.

### Means for Solving the Problem

The present inventors made various investigations on bleaching activators and noted that polyoxometalate is useful as a bleaching activator. The inventors found that if a polyoxometalate having a specific structure is used together with a bleaching agent (for example, hydrogen peroxide (H₂O₂)), such characteristics that inefficient decomposition of H₂O₂ is extremely suppressed and a generated species of activating oxidation can be effectively used for oxidation of a substrate are exhibited, and therefore, an effective utilization rate of organic peracids such as H₂O₂ or inorganic peracids can be increased, and in addition, a selectivity of the oxidation reaction is increased and bleaching effect can be increased. Further, the inventors found that such a bleaching activator not only activates a peroxy compound formed from the bleaching agent and a bleaching activator but also catalytically activates bleaching agents (inorganic peracid salts) and the like and its use amount can be reduced, in comparison to conventional TAED and NOBS. Therefore, a simple and economical bleaching activator can be provided. As a result, the above-mentioned problems can be admirably solved.

That is, the present invention is a bleaching activator comprising Keggin heteropolyoxometalate anions, wherein the Keggin heteropolyoxometalate anions comprise a Keggin heteropolyoxometalate anion represented by the following formula (1):

[XMₐ(H₂O)_{b}O_{c}]^{d-} (1)

(in the formula, X representing a silicon atom or a phosphorus atom; M being the same or different and representing a tungsten atom or a molybdenum atom; a representing an integer of 9 to 11; b representing a positive number of 0 to 6; c representing a positive number of 28 to 39; d representing a valency and being a positive number).

The present invention is also a detergent composition comprising the bleaching activator.

The present invention is mentioned in more detail below.

The bleaching activator of the present invention contains the Keggin heteropolyoxometalate anion represented by the above formula (1).

Some or all constituent anions in such a Keggin heteropolyoxometalate anion may have a structure shown in the above formula (1), in which some of oxygen atoms each bonded to the polyatom M are converted into water molecules, as represented by M—H₂O bond, or may be anions in which every polyatom is bonded to an oxygen atom, as typified by an anion represented by the formula (2). The bleaching activator essentially comprising Keggin heteropolyoxometalate anions may contain one or two or more different Keggin heteropolyoxometalate anions.

The Keggin heteropolyoxometalate anion represented by the above formula (1) has a crystal structure in which the heteroatom is a silicon atom (Si) or a phosphorus atom (P) and “a” (9 to 11) tungsten atoms (W) or molybdenum atoms (Mo) as the polyatom are coordinated with the heteroatom via an oxygen atom, and such an anion has 12-a deficient structure site(s) where 12-a polyatom(s) originally existing in the crystal structure are (is) deficient. For example, if a is 9, the anion has a deficient structure in which three polyatoms are deficient and such a structure is called a three-deficient structure. Similarly, if a is 10, the structure is called a two-deficient structure, and if a is 11, the structure is called a one-deficient structure. The “b” represents a site where some of the oxygen atoms each bonded to the polyatom at the deficient sites are converted into water. Thus, in the above formula (1), “a” and “b” determine the number of the deficient site and its structure, and can be arbitrarily determined by adjusting a molar ratio of starting materials, a concentration, a temperature, a pH, and the like, by publicly known means during preparation. The “c” and “d” are uniquely determined based on these “a” and “b”, and the valency of the heteroatom X and the polyatom M. The heteropolyoxometalate anion represented by the formula (1) may be a hydrate which forms a solid molecule together with a water molecule, or may be an anhydrate without a water molecule.

The above-mentioned polyatom is represented by M in the above formula (1), and is a tungsten atom (W) or a molybdenum atom (Mo). The tungsten atom (W) and the molybdenum atom (Mo) can form heteropolyoxometalate anions having the same structure because such atoms belong to 6 Group and the valencies thereof are the same.

Among the one-, two-, and three-deficient structures, a deficient structure having two or more deficient structure sites is preferable as the above-mentioned deficient structure.

Preferred examples of the above-mentioned Keggin heteropolyoxometalate anions having two or more deficient structure sites include an anion having three deficient structure sites in which 9 polyatoms are coordinated with the heteroatom. Thus, the preferable embodiments of the present invention include the bleaching activator, wherein the Keggin heteropolyoxometalate anions have three deficient structure sites and are represented by the following formula (2):

[XM₉O₃₄]^{e-} (2)

(in the formula, X representing a silicon atom or a phosphorus atom; M being the same or different and representing a tungsten atom or a molybdenum atom; and e representing a valency and being a positive number. Preferable embodiments of such a Keggin heteropolyoxometalate anions include an embodiment in which X represents a silicon atom; an embodiment in which M represents a tungsten atom; an embodiment in which a is 9 to 10; an embodiment in which b is 0 to 2; and an embodiment in which c is 34 to 36, in the above formula (1); and embodiments in which these embodiments are combined. More preferred is an embodiment in which all of the embodiments are combined, and such a Keggin heteropolyoxometalate anions are represented by the following formula (3).

[SiW₉O₃₄]¹⁰⁻ (3)

If the deficient structure site of the Keggin heteropolyoxometalate anions is noted, the preferred embodiments of the present invention include an embodiment in which some of W═O bonds and/or Mo═O bonds at the W sites and/or Mo sites each having an oxygen atom (terminal oxygen) positioned at deficient sites in W═O bonds and Mo═O bonds are converted into W—H₂O bonds and/or Mo—H₂O bonds. More preferred is an embodiment in which diagonally positioned two W═O bonds and/or Mo═O bonds of four W═O bonds and/or Mo═O bonds at two deficient sites are converted into W—H₂O bonds and/or Mo—H₂O bonds.

The above-mentioned Keggin heteropolyoxometalate anions can be obtained in salt form. With respect to the preparation method thereof, for example, it is preferable that the method described in “Inorganic Syntheses”, vol. 27, p. 71, 1990, is employed to generate salts of one- to three-deficient Keggin heteropolyoxometalate anions. An aqueous solution of such a salt is prepared and a pH thereof is adjusted, and thereby the Keggin heteropolyoxometalate anions in which M=O bonds (M is a tungsten atom or a molybdenum atom) at the deficient sites are converted into M-H₂O can be produced in salt form. In the production method of such a Keggin heteropolyoxometalate anions, whether or not the anion has a structure in which some oxygen atoms each bonded to the polyatom are converted into water molecules depends on the pH. In the present invention, the above-mentioned aqueous solution preferably has a pH of −1.0 or more and 7.0 or less, and more preferably 0 or more and 5.0 or less, and still more preferably 1.5 or more and 3.0 or less, and most preferably 2.0 or more and 2.5 or less.

If the Keggin heteropolyoxometalate anions of the present invention are in salt form, the salt has a counter cation. Preferred examples of such a counter cation include proton, alkali metal cations (lithium ion, sodium ion, potassium ion, rubidium ion, cesium ion), alkaline earth metal cations (beryllium ion, magnesium ion, calcium ion, strontium ion, barium ion), and organic cation-containing cations such as quaternary ammonium salts (e.g. tetramethylammonium salt, tetraethylammonium salt, tetrapropylammonium salt, tetrabutylammonium salt, tributylmethylammonium salt, trioctylmethylammonium salt, trilaurylmethylammonium salt, benzyltrimethylammonium salt, benzyltriethylammonium salt, benzyltributylammonium salt, cetylpyridinium salt, butylpyridinium salt, cetyltrimethylammonium salt, tetrapentylammonium salt, tetrahexylammonium salt, tetraoctylammonium salt, dimethyldioctadecylammonium salt) and quaternary phosphonium salts (e.g. tetramethylphosphonium salt, tetraethylphosphonium salt, tetrapropylphosphonium salt, tetrabutylphosphonium salt, tetraphenylphosphonium salt, ethyltriphenylphosphonium salt, benzyltriphenylphosphonium salt). Preferred are proton, lithium ion, sodium ion, potassium ion, cesium ion, tetramethylammonium salt, tetraethylammonium salt, tetrapropylammonium salt, tetrabutylammonium salt, trioctylmethylammonium salt, tetramethylphosphonium salt, tetraethylphosphonium salt, tetrapropylphosphonium salt, tetrabutylphosphonium salt, cetylpyridinium salt, and cetyltrimethylammonium salt. More preferred are proton, lithium ion, sodium ion, potassium ion, cesium ion, tetramethylammonium salt, tetraethylammonium salt, tetrapropylammonium salt, tetrabutylammonium salt, trioctylmethylammonium salt, and cetylpyridinium salt. One or two or more different cations may constitute the Keggin heteropolyoxometalate anions salt.

The above-mentioned Keggin heteropolyoxometalate anions may contain another anion as long as the anions essentially contain the anion represented by the above formula (1). Deficient (four or more-deficient) anions in which “a” in the above formula (1) is a positive integer of 8 or less may be mentioned as another anion. The above-mentioned Keggin heteropolyoxometalate anions also may contain another element. One or more different elements selected from elements belonging to 3 to 16 Groups in the periodic table may be mentioned as such another element, and such elements are different from the molybdenum atom or the tungsten atom which is the polyatom of the Keggin heteropolyoxometalate anions of the present invention. The species of another element may be appropriately determined depending on the species of the heteroatom of the Keggin heteropolyoxometalate anions. One or more different atoms selected from elements belonging to 3 to 11 Groups in the periodic table are preferable. Preferred examples of such another element include titanium, copper, iron, cobalt, manganese, vanadium, chromium, and ruthenium.

The content of the above-mentioned another element is preferably 0.0001 or more and more preferably 0.01 or more, relative to one heteroatom in the Keggin heteropolyoxometalate anions. The content is also preferably 6 or less, and more preferably 5 or less, and still more preferably 3 or less.

The above-mentioned another element may exist in cation form to take a charge balance with the heteropolyoxometalate anions, or may exist in oxide form, and the like.

With respect to the existing form of the another element and the Keggin heteropolyoxometalate anions in this case, the Keggin heteropolyoxometalate anions and the another element coexist, and for example, the following bonding forms (1) and (2) are preferable.

(1) A form in which the another element is coordinated by the Keggin heteropolyoxometalate anions, for example, like a complex compound shown by [XMₐ(H₂O)_{b}O_{c}]^{d-}-A-[XMₐ(H₂O)_{b}O_{c}]^{d-} (A representing the another element).

In the above form (1), the structure in which the another element is bonded to the Keggin heteropolyoxometalate anions can be identified or estimated by X-ray analysis, element analysis, or FT-IR spectrometry.

(2) A form in which the another element is supported on or absorbed to the Keggin heteropolyoxometalate anions. In this case, in the Keggin heteropolyoxometalate anions, the site where the another element is carried or absorbed, is not especially limited. Such a form is estimated by element analysis, FT-IR analysis, and the like.

In both of the above forms (1) and (2), difference between the heteroatom that is a silicon atom and/or a phosphorus atom in the Keggin heteropolyoxometalate, and the another element can be identified or confirmed by X ray analysis.

The bleaching activator essentially containing the Keggin heteropolyoxometalate anions according to the present invention is useful when used together with a bleaching agent, and oxidizes darkening or a compound which causes chromophore and contains at least one ethylenically double bond to show bleaching effects. If hydrogen peroxide is used as the bleaching agent, a peracid (peroxy compound) is generated on the metal (M) of the Keggin heteropolyoxometalate anions, and thereby the oxidation reaction is accelerated. Simultaneously, the use of the bleaching activator suppresses decomposition reaction of the peracid, and therefore the bleaching powder is improved without damage on clothes, for example. Thus, the above-mentioned bleaching activator is generally used with a bleaching agent, and if necessarily another bleaching activator may be also used together. The use of another bleaching activator not only generates a peracid (peroxy compound) on the metal (M) of the Keggin heteropolyoxometalate anions, but also peroxidizes the bleaching activators and thereby accelerates the oxidation reaction, which leads to improvement in oxidizing power.

The bleaching activator essentially containing the Keggin heteropolyoxometalate anions according to the present invention is expected to exhibit the following functional effects (1) to (6). That is, (1) efficient bleaching is permitted by epoxidation and a subsequent ring-opening diol reaction or bond cleavage of the above-mentioned ethylenically double bond; (2) a low-concentrated oxygen bleaching agent can be used; (3) an activator has high activity even at low temperatures; (4) inefficient decomposition of an oxygen oxidant is not caused, and therefore an effective utilization rate of the oxygen oxidant is increased; (5) the bleaching activator has a small environmental load; and (6) the bleaching activator does no damage on objects to be bleached such as clothes and tablewares, and does not remain.

If the Keggin heteropolyoxometalate anions of the present invention are used as a bleaching activator, a bleaching solution has a pH of 1 or more and 14 or less, and more preferably 2.0 or more and 13.8 or less, and still more preferably 2.5 or more and 13.0 or less.

The above-mentioned bleaching activator preferably contains the above-mentioned Keggin heteropolyoxometalate anions as a main component, and may contain impurity contents generated during preparation of the bleaching activator or other components, and may be used together with an activator capable of activating bleaching performance unless the functional effects of the present invention are sacrificed.

The present invention is also a detergent composition comprising the bleaching activator.

The above-mentioned detergent composition is so-called a cleaning agent, a bleaching agent, or a detergent having functions such as removal of stains on clothes or tablewares. As the oxygen bleaching agent, generally, a bleaching agent including peracid (salt), a bleaching activator for activating oxidation reaction attributed to such a bleaching agent, or the like is used or they are used in combination. Such a detergent composition is one of the preferable embodiments of the present invention. Such a detergent composition essentially containing the bleaching activator is also included in the present invention.

The above-mentioned detergent composition generally contains a bleaching agent in addition to the bleaching activator. Such a detergent composition essentially containing the bleaching activator and a bleaching agent is also one of the preferable embodiments of the present invention.

Organic and inorganic peracids (salts) and hydrogen peroxide are preferable as the above-mentioned bleaching agent. One or two or more species of them may be used.

Preferred examples of the above-mentioned organic peracids (salts) include monoperoxycarboxylic acids such as t-butylperoxide, peracetic acid, peroxybenzoic acid, peroxynonanoic acid, peroxylauric acid, and monoperoxyphthalic acid, and salts thereof; diperoxycarboxylic acids such as 2-alkylperoxy-1,4-butanedioic acid, 1,7-heptanediperoxycarboxylic acid, 1,9-nonanediperoxycarboxylic acid, 1,12-dodecanediperoxycarboxylic acid, and diperoxyphthalic acid, and salts thereof; peroxycarboxylic acids with an amide bond in the hydrocarbon chain such as N-decanoylaminoperoxycaproic acid, 5-(N-nonylcarbamoyl)peroxyvaleric acid, and 3-(N-nonylcarbamoyl)peroxypropionic acid, and salts thereof; sulfonylperoxycarboxylic acids such as 4,4′-sulfonyldiperoxybenzoic acid, 3,3′-sulfonyldiperoxypropionic acid, 4-methylsulfonylperoxybenzoic acid, and 3-decylsulfonylperoxypropionic acid, and salts thereof; and unsubstituted, or mono- or polysubstituted phthaloylaminoperoxycarboxylic acids such as N,N′-phthaloylaminoperoxy-n-hexanoic acid (PAP) and N,N′-phthaloylaminoperoxylauric acid.

Preferred examples of the above-mentioned inorganic peracids (salts) include perboric acid, percarbonic acid, perphosphoric acid, persulfuric acid, hydrogen peroxide, and salts thereof.

If the above-mentioned organic and inorganic peracids are in salt form, the counter cations mentioned in the embodiment in which the above-mentioned Keggin heteropolyoxometalate anions are in salt form are preferable.

Perboric acid, percarbonic acid, persulfuric acid, and hydrogen peroxide are more preferable and perboric acid, percarbonic acid, and hydrogen peroxide are still more preferable as the above-mentioned bleaching agent.

If the bleaching activator is used in powdered products, preferable bleaching agents are perborates such as sodium peroborate monohydrate and tetrahydrate; percarbonates such as sodium percarbonate; and persulfate (salts).

The above-mentioned detergent composition may contain another bleaching activator. If another bleaching activator is used together, the efficiency as a detergent can be improved.

The above-mentioned another bleaching activator is not especially limited as long as it has an effect of activating bleaching performance. Examples thereof include N-acylated amines, N-acylated diamines, N-acylated amides, and glycolurils, tetraacetylmethylenediamine, tetraacetylethylenediamine (TAED), diacetylaniline, diacetyl-p-toluidine, 1,3-diacetyl-5,5-dimethylhydantoin, tetraacetylglycoluril, tetrapropionylglycoluril, 1,4-diacetyl-2,5-diketopiperazine, 1,4-diacetyl-3,6-dimethyl-2,5-diketopiperazine, and diacetyldioxohexahydrotriazine (DADHT); acyloxybenzenesulfonates such as nonanoyloxybenzenesulfonate (NOBS) and benzoyloxybenzenesulfonate (BOBS); acylated sugars such as pentaacetylglucose (PAG); sugar derivatives such as sugar amides; activated carboxylic esters; carboxylic anhydrides such as isatoic anhydride, maleic anhydride, succinic anhydride, and citric anhydride; lactones; acylals; acyllactams such as nonanoyl caprolactam and benzoylcaprolactam; alkanenitriles and arenenitriles. TAED and NOBS are more preferable. One or two or more species of these bleaching activators may be used.

The above-mentioned detergent composition may further contain one or two or more different additives.

Examples thereof include sufactant compounds such as anionic, nonionic, zwitterionic (amphoteric), and cationic surfactants, alkali agents, builders, cobuilders, enzymes, and other components.

The above-mentioned surfactants may be natural or synthetic surfactants. Preferred examples of anionic surfactants include alkylbenzene sulfonates such as alkyl sulfates, alkylsulfonates, sodium dodecylbenzene sulfonate, α-sulfo fatty acid salts or esters such as alkylarylsulfonate and α-sulfo fatty acid methyl ester, soaps, alkyl ether sulfonates, olefin sulfonates, alkane sulfonates, higher fatty acid salts, alkyl or alkenyl ether sulfates, and alkyl or alkenyl sulfonates. Also preferred are nonionic surfactants such as alkyl polyglycol ethers, alkylpolyglucosides, glucamides, sugar esters and amine oxides, polyoxyalkylene alkyl or alkenyl ethers, polyoxyethylene alkylphenyl ethers, higher fatty acid alkanolamides or alkylene oxide adducts thereof, alkylene amine oxides; amphoteric surfactants such as amino acid type or betaine type carboxylic acid salt amphoteric surfactants and sulfonic acid salt amphoteric surfactants such as sulfobetain; and cationic surfactants typified by quaternary ammonium surfactants.

Preferred examples of the above-mentioned alkali agents include hydroxides of alkali metals, such as sodium hydroxide and potassium hydroxide; carbonates such as sodium carbonate, sodium hydrogencarbonate, and potassium carbonate; silicates such as sodium orthosilicate, potassium orthosilicate, sodium metasilicate, and potassium metasilicate.

Water-soluble or water-insoluble and organic or inorganic builders and cobuilders may be used as the above-mentioned builders and cobuilders. Specifically, preferred are phosphates such as sodium polyphosphate, amino polyacetates, oxycarboxylates, polyelectrolytes, A, X, and P type zeolites, alkali metal carbonates and alkali metal hydrogen carbonates, and amorphous and crystalline silicates. More preferable as the silicates are phyllosilicates and bisilicates. Preferred examples of the above-mentioned cobuilders include organic carboxylic acids such as citric acid and amino acid; polyacrylic acid polymers, and copolymers of acrylic acid and maleic acid or derivatives thereof. Further, phosphonates or other complexing agents may be added.

Preferred examples of the above-mentioned enzymes include amylases, proteases, lipases, cellulases, and peroxidases. The above-mentioned other components include cellulose ether, silicon, bentonite, fluorescent whitener, and perfume.

One or two or more species of the above-mentioned other additives may be used.

With respect to the proportion of the bleaching activator, the bleaching agent, and the another bleaching activator each constituting the detergent composition of the present invention, the bleaching agent is preferably 0.005 to 200000 parts by weight, and more preferably 0.5 to 100000 parts by weight, relative to 100 parts by weight of the bleaching activator. The another bleaching activator is preferably 0 to 200000 parts by weight, and more preferably 0 to 100000 parts by weight. Further, other additives may be added if necessary, and are preferably 0 to 100000 parts by weight and more preferably 0 to 90000 parts by weight.

The detergent composition essentially containing the bleaching activator of the present invention may appropriately contain generally used various additives and the like, depending on applications. For example, if the detergent composition is used as a laundry cleaner or detergent mainly used for removal of stains on clothes, the detergent composition may contain a surfactant, a builder, an alkali agent, an inorganic electrolyte, an anti-soil redeposition agent, a bleaching agent, a detergent, a brightener, a fluorescent coating material, a perfume, an enzyme, a bleaching activator, a solubilizing agent, and the like. These may be appropriately selected and used for exhibition of the functional effects of the present invention. Additives described in Japanese Kokai Publication No. Hei-08-104892 and Japanese Kokai Publication No. 2005-232450 may be mentioned. If the detergent composition is used as a detergent for dishwashers mainly used for removal of stains on tablewares, the detergent composition may contain an alkali agent, a surfactant, an oxidant, a dispersant, a chelating agent, a solvent, an enzyme, an inorganic metal salt, an organic and/or inorganic solidification agent, a pH adjustor, an antibacterial agent, a fungicide, a deodorant, a stabilizer, a polymer, an inorganic salt, and the like. These additives may be appropriately selected and used for exhibition of the functional effects of the present invention, and those described in Japanese Kokai Publication No. Hei-10-226800 and Japanese Kokai Publication No. 2003-231542 may be mentioned, for example. In addition, the detergent composition may contain generally used various additives, in addition to those described in the above-mentioned publications.

The content of the above-mentioned additives is not especially limited and may be appropriately determined depending on applications as long as the functional effects of the present invention are exhibited. Such additives may be used in the manners described in the above-mentioned publications. If the detergent composition is used as a laundry cleaner or detergent and the like, for example, the content of the surfactant is preferably within a range where the detergent performances and stabilization of the solution are both sufficient. The content is preferably 1 to 99% by weight and more preferably 5 to 90% by weight, relative to the total amount of the detergent.

The content of the alkali agent if the detergent composition is used as a detergent for dishwashers is preferably 1 to 90% by weight and more preferably 5 to 80% by weight, relative to the total amount of the detergent.

The above-mentioned detergent composition may be used as cleaners and detergents, for example, a cleaner for clothes, a heavy duty cleaner, a multicomponent cleaner (modular system), a scouring salt, a stain pretreatment agent, a detergent for automatic dishwashers, a detergent for hard surfaces, a disinfectants, and a detergents for false teeth. The detergent composition also has a function as a dye transfer-inhibiting agent, in addition to the bleaching function.

The use amount of the above-mentioned detergent composition is, relative to the total amount of the detergent, 2 to 40% by weight in use as a heavy duty cleaner; 20 to 100% by weight in use as a scouring salt and a laundry pretreatment agent; 1 to 30% by weight in use as a detergent for dishwasher; 2 to 50% by weight in use as a detergent for hard surface and a disinfectant detergent; and 2 to 20% by weight in use as a detergent for false teeth. The above-mentioned detergent composition can be added in the form of a powder or as granules to the cleaners and detergents.

### EFFECT OF THE INVENTION

The bleaching activator and the detergent composition containing such a compound of the present invention have the above-mentioned configurations, and can improve bleaching performance of a peroxy compound and the like, and they are useful for bleaching stains on clothes or removing stains such as tea stain on ceramic, glass, or plastic tablewares.

### BEST MODES FOR CARRYING OUT THE INVENTION

The present invention is mentioned in more detail below with reference to Examples, but the present invention is not limited to only these Examples.

### Examples 1 to 7

Bleaching activators K₈[α-SiW₁₁O₃₉], K₈[γ-SiW₁₀O₃₆], Na₁₀[α-SiW₉O₃₄], (NH₄)₇[α-PW₁₁O₃₉] were prepared by the method described in “Inorganic Syntheses”, vol. 27, p. 71, 1990. K₈[α-SiMo₂W₉O₃₉] was prepared by the method described in “Inorganic Chemistry”, vol. 31, p. 4128, 1992. (Bu₄N)₄[γ-SiW₁₀(H₂O)₂O₃₄] was prepared by the method described in “Science”, vol. 300, p. 964, 2003.

Pure water 1 L was charged into a beaker of a Terg-O-Tometer (product of DAIEI KAGAKU SEIKI MFG. co., ltd.), and the temperature was set at 40° C. Into this beaker, the bleaching activator of the present invention and a bleaching agent (35% hydrogen peroxide solution or sodium percarbonate) were added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the following formula, and the bleaching performance was evaluated.

Ratio of increase in whiteness(%)=(C−B)/(A−B)×100

A: whiteness of a white fabric before being stained with red wine
B: whiteness of a fabric stained with red wine
C: whiteness after the bleaching test

### Example 8

Pure water 1 L was charged into a beaker of a Terg-O-Tometer (product of DAIEI KAGAKU SEIKI MFG. co., ltd.), and the temperature was set at 20° C. Into this beaker, the bleaching activator Na₁₀[α-SiW₉O₃₄] (1.33 g) of the present invention and 35% hydrogen peroxide solution (5.0 g) were added, and thereinto a cotton fabric (5×4.5 cm) stained with red wine was added, and the mixture was stirred for 15 minutes. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

### Comparative Example 1

Pure water 1 L was charged into a beaker of a Terg-O-Tometer (product of DAIEI KAGAKU SEIKI MFG. co., ltd.), and the temperature was set at 40° C. Into this beaker, a bleaching agent (35% hydrogen peroxide solution) (5.0 g) was added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

### Comparative Example 2

A bleaching activator K₄[α-SiW₁₂O₄₀] was prepared by the method described in “Inorganic Syntheses”, vol. 27, p. 71, 1990.

Pure water 1 L was charged into a beaker of a Terg-O-Tometer (product of DAIEI KAGAKU SEIKI MFG. co., ltd.), and the temperature was set at 40° C. Into this beaker, the K₄[α-SiW₁₂O₄₀] (1.26 g) and a bleaching agent (35% hydrogen peroxide solution) (5.0 g) were added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

### Comparative Examples 3 and 4

A bleaching activator Na₁₁(NH₄) [Mn₃ (SbW₉O₃₃)₂] was prepared by the method described in “Journal of the American Chemical Society”, vol. 120, p. 7252, 1998.

Pure water 1 L was charged into a beaker of a Terg-O-Tometer (product of DAIEI KAGAKU SEIKI MFG. co., ltd.), and the temperature was set at 20° C. Into this beaker, the bleaching activator and 35% hydrogen peroxide solution (5.0 g) were added, and thereinto a cotton fabric (5×4.5 cm) stained with red wine was added, and the mixture was stirred for 15 minutes. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

TABLE 1

| | | | | | | Ratio of |
|---|---|---|---|---|---|---|
| | | Addition | | Addition | Stirring | increase in |
| | | amount | | amount | time | whiteness |
| | Bleaching agent | (g) | Bleaching activator | (g) | (min) | (%) |
| Example 1 | Hydrogen peroxide | 5.0 | K₈[α-SiW₁₁O₃₉] | 1.45 | 5 | 41 |
| Example 2 | Hydrogen peroxide | 5.0 | K₈[γ-SiW₁₀O₃₆] | 1.35 | 5 | 42 |
| Example 3 | Hydrogen peroxide | 5.0 | Na₁₀[α-SiW₉O₃₄] | 1.33 | 5 | 49 |
| Example 4 | Hydrogen peroxide | 5.0 | (Bu₄N)₄[γ-SiW₁₀(H₂O)₂O₃₄] | 1.35 | 5 | 40 |
| Example 5 | Sodium | 7.9 | Na₁₀[α-SiW₉O₃₄] | 1.33 | 15 | 91 |
| | percarbonate | | | | | |
| Example 6 | Hydrogen peroxide | 5.0 | (NH₄)₇[α-PW₁₁O₃₉] | 1.27 | 5 | 40 |
| Example 7 | Hydrogen peroxide | 5.0 | K₈[α-SiMo₂W₉O₃₉] | 1.26 | 5 | 41 |
| Comparative | Hydrogen peroxide | 5.0 | No added | No added | 5 | 34 |
| Example 1 | | | | | | |
| Comparative | Hydrogen peroxide | 5.0 | K₄[α-SiW₁₂O₄₀] | 1.26 | 5 | 38 |
| Example 2 | | | | | | |

TABLE 2

| | | | Ratio of |
|---|---|---|---|
| | | Addition | increase in |
| | | amount | whiteness |
| | Bleaching activator | (g) | (%) |
| Example 8 | Na₁₀[α-SiW₉O₃₄] | 1.33 | 45 |
| Comparative | Na₁₁(NH₄)[Mn₃(SbW₉O₃₃)₂] | 1.38 | 27 |
| Example 3 | | | |
| Comparative | K₄[α-SiW₁₂O₄₀] | 1.26 | 32 |
| Example 4 | | | |

### Example 9

Pure water 1 L was charged into a beaker of a Terg-O-Tometer (product of DAIEI KAGAKU SEIKI MFG. co., ltd.), and the temperature was set at 20° C. Into this beaker, the Na₁₀[α-SiW₉O₃₄] (0.25 g) of the present invention and sodium perborate (0.75 g) were added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

### Comparative Example 5

Pure water 1 L was charged into a beaker of a Terg-O-Tometer (product of DAIEI KAGAKU SEIKI MFG. co., ltd.), and the temperature was set at 20° C. Into this beaker, sodium perborate (0.75 g) was added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

### Comparative Example 6

Pure water 1 L was charged into a beaker of a Terg-O-Tometer (product of DAIEI KAGAKU SEIKI MFG. co., ltd.), and the temperature was set at 20° C. Into this beaker, tetraacetylethylenediamine (TEAD) (0.25 g) and sodium perborate (0.75 g) were added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

TABLE 3

| | | Ratio of |
|---|---|---|
| | | increase h |
| | | whiteness |
| | Bleaching activator | (%) |
| Example 9 | Na₁₀[α-SiW₉O₃₄] | 53 |
| Comparative | No added | 39 |
| Example 5 | | |
| Comparative | TAED | 50 |
| Example 6 | | |

### Example 10

Pure water 1 L was charged into a beaker of a Terg-O-Tometer (product of DAIEI KAGAKU SEIKI MFG. co., ltd.), and the temperature was set at 20° C. Into this beaker, the Na₁₀[α-SiW₉O₃₄] (0.25 g), sodium perborate (0.75 g), and 6% aqueous solution of sodium dodecylbenzenesulfonate (LAS) (5 g) were added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

### Comparative Example 7

Pure water 1 L was charged into a beaker of a Terg-O-Tometer (product of DAIEI KAGAKU SEIKI MFG. co., ltd.), and the temperature was set at 20° C. Into this beaker, sodium perborate (0.75 g) and 6% aqueous solution of sodium dodecylbenzenesulfonate (LAS) (5 g) were added, and thereinto a cotton fabric (5×4.5 cm) stained with red wine was added, and the mixture was stirred for a specific time. At this time, the rotation speed indicator was set to 100. Immediately after bleaching, the cotton fabric was removed from the beaker and washed well with pure water, and then ironed and dried. After drying, the cotton fabric was measured for whiteness with a color difference meter SE-2000 (product of Nippon Denshoku Industries Co., Ltd.). Based on the whitenesses before and after the bleaching, a ratio of increase in whiteness was calculated from the above formula, and the bleaching performance was evaluated.

TABLE 4

| | | Ratio of |
|---|---|---|
| | | increase h |
| | | whiteness |
| | Bleaching activator | (%) |
| Example 10 | Na₁₀[α-SiW₉O₃₄] | 32 |
| Comparative | No added | 27 |
| Example 7 | | |

1. A bleaching activator comprising Keggin heteropolyoxometalate anions, wherein the Keggin heteropolyoxometalate anions comprise a Keggin heteropolyoxometalate anion represented by the following formula (1):
[XMₐ(H₂O)_{b}O_{c}]^{d-} (1)
(in the formula, X representing a silicon atom or a phosphorus atom; M being the same or different and representing a tungsten atom or a molybdenum atom; a representing an integer of 9 to 11; b representing a positive number of 0 to 6; c representing a positive number of 28 to 39; d representing a valency and being a positive number).

2. The bleaching agent according to claim 1, wherein the Keggin heteropolyoxometalate anions have two or more deficient structure sites.

3. The bleaching activator according to claim 1, wherein the Keggin heteropolyoxometalate anions have three deficient structure sites and is represented by the following formula (2):
[XM₉O₃₄]^{e-} (2)
(in the formula, X representing a silicon atom or a phosphorus atom; M being the same or different and representing a tungsten atom or a molybdenum atom; and e representing a valency and being a positive number.

4. A detergent composition comprising the bleaching activator of claim 1.

5. The bleaching activator according to claim 2, wherein the Keggin heteropolyoxometalate anions have three deficient structure sites and is represented by the following formula (2):
[XM₉O₃₄]^{e-} (2)
(in the formula, X representing a silicon atom or a phosphorus atom; M being the same or different and representing a tungsten atom or a molybdenum atom; and e representing a valency and being a positive number.

6. A detergent composition comprising the bleaching activator of claim 2.

7. A detergent composition comprising the bleaching activator of claim 3.

8. A detergent composition comprising the bleaching activator of claim 5.
